(19) United States
(12) Patent Application Publication
(10) Pub. No.: US 2017/0324672 A1
(43) Pub. Date: Nov. 9, 2017

(54) DEVICE AND METHOD FOR TRANSMITTING PACKET IN WIRELESS COMMUNICATION SYSTEM

(71) Applicants: Samsung Electronics Co., Ltd., Suwon-si (KR); UNIST(ULSAN NATIONAL INSTITUTE OF SCIENCE AND TECHNOLOGY), Ulsan (KR)

(72) Inventors: Jinsung Lee, Suwon-si (KR); Kyunghan Lee, Ulsan (KR); Sangjun Moon, Seoul (KR); Jung Shin Park, Seoul (KR); Jicheol Lee, Suwon-si (KR); Joohyung Lee, Gwacheon-si (KR)

(21) Appl. No.: 15/586,150

(22) Filed: May 3, 2017

(30) Foreign Application Priority Data
May 3, 2016 (KR) 10-2016-0054688

(51) Int. Cl. H04L 12/841; H04W 24/08; H04L 12/26; H04W 84/04; H04L 29/06

(52) U.S. Cl. CPC H04L 47/283; H04W 24/08; H04L 43/0864; H04L 69/163; H04W 84/042

(57) ABSTRACT

The present disclosure relates to a pre-5^{th}-Generation (5G) or 5G communication system to be provided for supporting higher data rates Beyond 4^{th}-Generation (4G) communication system such as Long Term Evolution (LTE). An operation method of a transmission device according to an embodiment includes determining the amount of packets transferred from an application layer to a buffer and determining the amount of packets transferred from the buffer to a transmission layer. The method also includes blocking/non-blocking a packet transfer from the application layer to the buffer, based on the amount of packets transferred from the application layer to the buffer and the amount of packets transferred from the buffer to the transmission layer.

### TECHNICAL FIELD

In general, following descriptions relate to packet transmission in a wireless communication system and, more particularly, to a device and method for reducing a latency time in transmission of a packet.

### BACKGROUND

To meet the demand for wireless data traffic having increased since deployment of 4^{th} generation (4G) communication systems, efforts have been made to develop an improved 5^{th} generation (5G) or pre-5G communication system. Therefore, the 5G or pre-5G communication system is also called a ‘Beyond 4G Network’ or a ‘Post Long Term Evolution (LTE) System’.

The 5G communication system is considered to be implemented in higher frequency (mmWave) bands, e.g., 28GHz or 60GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems.

In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like.

In the 5G system, Hybrid frequency shift keying (FSK) and quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The primary goal to be considered in designing a transmission control protocol (TCP) algorithm has been to maximize utilization of an available bandwidth of a given network by probing the available bandwidth in a short time. To this end, most TCPs initiate control and concurrently perform an operation for finding the maximum available bandwidth in a short time by aggressively increasing the amount of packets injected into the network. At this time, if a transmission end cannot secure enough amount of packets to be injected into the network, the TCP cannot sufficiently increase a transmission rate due to characteristics of TCP, in which the size of a transmission window (congestion window (CWND)) is controlled based on an acknowledge (ACK) message for packets having been transmitted.

### SUMMARY

To address the above-discussed deficiencies, it is a primary object to provide an operation method and device of a transmission end in a wireless communication system.

Another embodiment provides a device and method for reducing a transmission latency in a transmission end in a wireless communication system.

Still another embodiment provides a device and method for reducing a latency in a transmission buffer of a transmission control protocol (TCP) socket in a transmission end in a wireless communication system.

Still another embodiment provides a structure of a TCP socket for reducing a latency in a transmission end in a wireless communication system.

Still another embodiment provides a device and method for controlling the packet amount of a transmission buffer of a TCP socket, in a wireless communication system.

Still another embodiment provides a device and method for controlling blocking/non-blocking of a transmission buffer of a TCP socket in a transmission end in a wireless communication system.

An operation method of a transmission device according to an embodiment includes: determining the amount of packets transferred from an application layer to a buffer; determining the amount of packets transferred from the buffer to a transmission layer; and blocking a packet transfer from the application layer to the buffer, based on the amount of packets transferred from the application layer to the buffer and the amount of packets transferred from the buffer to the transmission layer.

A transmission device according to another embodiment includes a buffer that serves to temporarily store a packet, and a control unit that blocks a packet transfer to the buffer based on the amount of packets transferred from an application layer to the buffer and the amount of packets transferred from the buffer to a transmission layer.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For more complete understanding of the present disclosure and its advantages, reference is now made to the following description taken in conjunction with the accompanying drawings, in which like reference numerals represent like parts:

FIG. 1 illustrates a wireless communication network environment;

FIG. 2 illustrates an end-to-end latency at an application level in transmission of a packet;

FIG. 3 illustrates a transmission buffer structure of a transmission control protocol (TCP) socket according to an embodiment;

FIG. 4 illustrates a functional block configuration of a transmission end according to an embodiment;

FIG. 5 illustrates a functional block configuration of a control unit according to an embodiment;

FIG. 6 illustrates an operation flow of a transmission end according to an embodiment; and

FIG. 7 illustrates another operation flow of a transmission end according to an embodiment.

### DETAILED DESCRIPTION

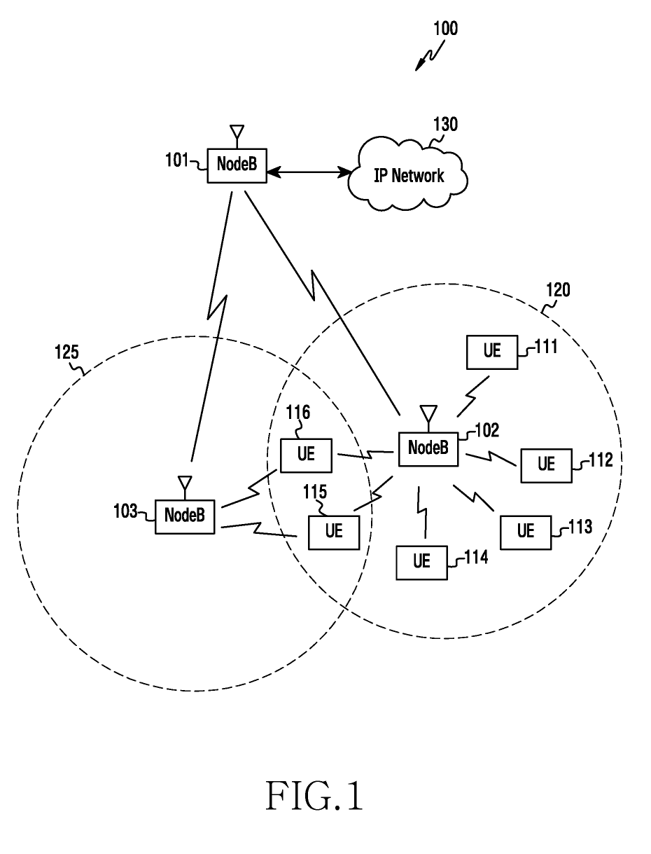

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

In the above-described detailed embodiments of the present disclosure, a component included in the present disclosure is expressed in the singular or the plural according to a presented detailed embodiment. However, the singular form or plural form is selected for convenience of description suitable for the presented situation, and various embodiments of the present disclosure are not limited to a single element or multiple elements thereof. Further, either multiple elements expressed in the description may be configured into a single element or a single element in the description may be configured into multiple elements.

Although the present disclosure has been described with an exemplary embodiment, various changes and modifications may be suggested to one skilled in the art. It is intended that the present disclosure encompass such changes and modifications as fall within the scope of the appended claims.

A hardware access method is exemplified in the various embodiments which will be described below. However, the various embodiments include a technology using both hardware and software, and therefore a software-based access method is not excluded from the various embodiments.

The present disclosure describes a device and method for reducing a latency when a packet is transmitted in a wireless communication system. Here, the latency to be reduced occurs in a transmission end or a transmission device and, more particularly, occurs due to buffering in a transmission buffer.

FIG. 1 illustrates a wireless communication network environment. FIG. 1 illustrates an example of a wireless network environment 100 according to an embodiment. The wireless network environment 100 illustrated in FIG. 1 is merely illustrative. Other examples of the wireless network environment 100 may be used without departing from the scope of the present disclosure.

The wireless network environment 100 includes a NodeB 101, a NodeB 102, and a NodeB 103. The NodeB 101 communicates with the NodeB 102 and the NodeB 103. The NodeB 101 also communicates with an Internet Protocol (IP) network 130, such as the Internet, a proprietary Internet Protocol (IP) network, or other data networks.

Depending on a network type, other well-known terms, such as “a transmission point (TP)”, a base station (BS)”, “an access point (AP)”, or “eNodeB (eNB)”, may be used instead of “NodeB”. For convenience, the term NodeB is used to refer to network infrastructure components that provide wireless access to remote terminals, in the present specification.

For the sake of convenience, a term “user terminal” or “user equipment (UE)” is used hereinbelow to indicate a remote wireless terminal that wirelessly accesses NodeB, and it is thus independent of whether the UE is assumed to be a mobile device (e.g., a cellular phone) or the UE is assumed, as a usual case, to be a fixed device (e.g., a desktop PC, a vending machine, etc.). In other systems, other well-known terms, such as “mobile station (MS)”, “subscriber station (SS)”, “remote terminal (RT)”, and “wireless terminal (WT)”, may be used instead of “user terminal”.

The NodeB 102 provides wireless broadband access to the network 130, to a plurality of first UEs within a coverage area 120 of the NodeB 102. The plurality of the first UEs include: a UE 111 that may be located in a small and medium-sized enterprise; a UE 112 that may be located in a large enterprise; a UE 113 that may be located in a Wi-Fi hotspot; a UE 114 that may be located in a first house; a UE 115 that may be located in a second house; and a UE 116 that may be a mobile device, such as a cellular phone, a wireless laptop, and a wireless PDA. The UEs 111 to 116 may not be limited to the description above, but may be wireless communication devices, such as a mobile phone, a mobile PDA, and an MS.

The NodeB 103 provides wireless broadband access to a plurality of second UEs within a coverage area of the NodeB 103. The plurality of the second UEs includes the UE 115 and the UE 116. In some embodiments, one or more NodeBs among NodeBs 101 to 103 may communicate with each other and communicate with the UEs 111 to 116, using LTE or LTE-A techniques including techniques for using control channel elements of PDCCHs, as described in embodiments of the present disclosure.

Dotted lines indicate schematic ranges of the coverage areas 120 and 125 which have been illustrated in schematic circular shapes only for the purpose of illustration and description. It should be clearly understood that coverage areas associated with base stations, for example, the coverage areas 120 and 125, may have other shapes including irregular shapes depending on configurations of base stations and changes in a wireless environment associated with natural and artificial obstacles.

FIG. 1 illustrates an example of the wireless network environment 100, but various modifications may be made relating to FIG. 1. For example, the wireless network environment 100 may be replaced with a data network having a different type, such as a wired network. In a wired network, the NodeBs 101 to 103 and the UEs 111 to 116 may be replaced with network terminals. Wireless connections illustrated in FIG. 1 may be replaced with wired connections.

In various embodiments, a transmission end may be a terminal. The terminal may be a portable electronic device, and may be one of a smart phone, a portable terminal, a mobile phone, a mobile pad, a media player, a tablet computer, a handheld computer, and a Personal Digital Assistant (PDA). Further, the electronic device may be a device having a function, which is generated by combining two or more functions of the above described devices.

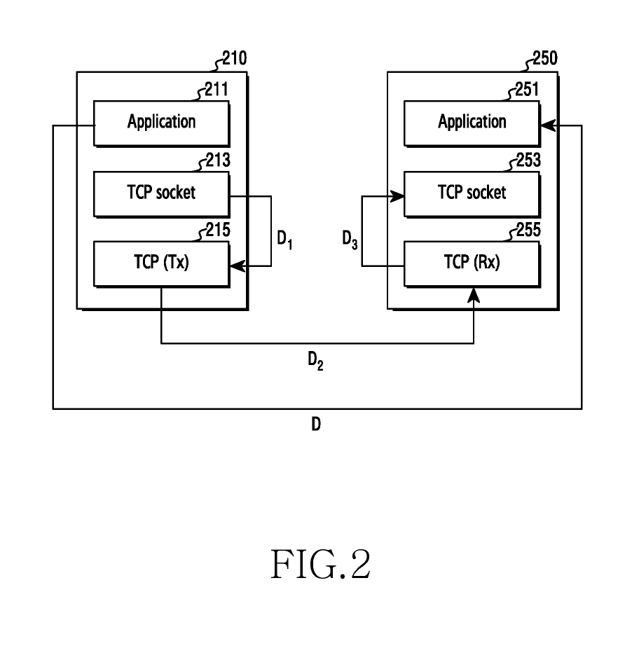

FIG. 2 illustrates an end-to-end latency at an application level in transmission of a packet.

In FIG. 2, a transmission end 210 may be at least one of a base station, a terminal, and a server device. In addition, a reception end 250 may be at least one of a base station, a terminal, and a server device. For example, when it is assumed to be device-to-device (D2D) communication, the transmission end 210 may be a first terminal, and the reception end 250 may be a second terminal. The transmission end and the reception end may be referred to be as a transmission device and a reception device, respectively.

Referring to FIG. 2, an end-to-end application transmission latency time between the transmission end 210 and the reception end 250 is expressed as variable D. Various embodiments propose a solution for reducing transmission latency time D.

Referring to FIG. 2, a packet that is to be a transmission object between the transmission end 210 and the reception end 250 is generated by an application 211. The packet is transferred from the application 211 to a transmission control protocol (hereinafter, referred to as “TCP”) socket 213 for the purpose of transmission. The TCP socket 213 has a transmission buffer, and the packet is temporarily stored in the transmission buffer. That is, the packet is stored in the transmission buffer of the TCP socket until an acknowledge (ACK) message is received from the reception end 250. In some embodiments, the transmission buffer would be technically equivalent to and referred as a send buffer.

The packet temporarily stored in the transmission buffer is transferred to a TCP transmission layer 215 in order to be transmitted to the reception end 250. If the packet generated by the application 211 is transmitted through the network as soon as the packet is transferred to the TCP socket 213, latency time D during which the packet is transferred from the transmission end 210 to the reception end 250 includes only network latency time D2. However, a transmission latency may occur in a case where sufficient amount of packets cannot be transferred to the TCP transmission layer 215 in a procedure of transferring the packets from the transmission buffer of the TCP socket 213 to the TCP transmission layer 215. In the present disclosure, this latency is defined as transmission end socket latency time D1.

The reception end 250 receives a packet through the network. The reception end 250 transfers the packet received through a TCP layer 255 to a TCP socket 253, and reception end socket latency D3 is generated in this procedure.

Application transmission latency time D may be expressed as EQUATION 1 below.

D=D1+D2+D3 [EQUATION 1]

In EQUATION 1, D denotes the application transmission latency time between the transmission end and the reception end, D1 denotes the transmission end socket latency time, D2 denotes the network latency time, and D3 denotes the reception end socket latency time.

If transmission end socket latency time D1 is relatively large, there may occur a fatal problem in which the packet should wait for a time longer than network latency time D2 at the transmission end 210 itself. The present disclosure aims at reducing application transmission latency time D between the transmission end 210 and the reception end 250. More particularly, various embodiments aim at reducing transmission end socket latency time D1 in transmission latency time D.

When it is intended to eliminate transmission end socket latency time D1 occurred at the transmission end 210 by packets accumulated in the transmission buffer of the TCP socket 213, a technique of fixing the size of the transmission buffer to be small or limiting a maximum value while operating the transmission buffer using a scheme, such as an auto-tuning scheme, may be used.

However, the technique of limiting the size of the transmission buffer may occur a problem of lowering a transmission rate. More particularly, when the transmission buffer has N packets and one of the N packets is transmitted through the network, the corresponding packet is classified as “a packet in flight” and occupies a space within the transmission buffer until an ACK message is received. This serves to facilitate retransmission when the corresponding packet is lost. The corresponding packet is deleted from the transmission buffer only if ACK message for the packet is normally received. Then, the transmission buffer loads a new packet from a storage (i.e., an application) according to a transmission window control technique. In a simple example, the transmission buffer loads two packets for one ACK message, in the slow-start interval of TCP New Reno. This procedure proceeds with time sliding. However, if the size of the transmission buffer is fixed to be a specific size, a situation in which the transmission buffer is unable to load an additional packet occurs. That is, the transmission end 210 can fill a space generated while deleting one packet which has received the ACK message, but cannot load more packets than that. Accordingly, a transmission window, the size of which is inevitably limited by the transmission buffer, cannot be increased beyond a specific value, and a transmission rate decline phenomenon, in which an available bandwidth cannot be fully utilized, may occur.

Various embodiments propose a method of dramatically lowering a latency time in the transmission buffer, by escaping from a conventional transmission buffer control technique. Ultimately, various embodiments aim at making a latency time in the transmission buffer close to 0 ms, thereby transferring the packet instantly generated by the application 211 of the transmission end 210 to the reception end 250 without an additional unnecessary latency other than network latency time D2.

Various embodiments are associated with an operation in a TCP transmission end. The present disclosure includes two elements which are a transmission application and a kernel having a TCP protocol stack. Here, the transmission application means all applications using TCP socket programming.

In relation to ordinary TCP socket programming, a TCP socket existing within a TCP protocol stack manages a transmission buffer, and it is thus based on particularity of the structure that the present disclosure may include a transmission application as an element. However, it is also possible to implement the present disclosure using only a kernel having a TCP protocol stack, without a transmission application.

Implementation methods according to various embodiments may be broadly divided into two types. First, various embodiments may be implemented through application programming that refers to kernel information. Second, various embodiments may be implemented through TCP socket programming using only information about the inside of a kernel. Here, the present disclosure concentrates on implementation through application programming that refers to kernel information. However, it may be intuitively understood that the disclosure relating to implementation through application programming that refers to kernel information may be applied to implementation through TCP socket programming using only information about the inside of a kernel. Therefore, the technique is omitted.

A technique according to an embodiment requires modification in the following programming code for transmitting data through a TCP socket in ordinary TCP socket programming. A codeword as shown in TABLE 1 below may exist within the application.

TABLE 1

while (1) {
write (socket, buffer, n);
}

The meaning of the code is to copy n bytes of data to a TCP socket (i.e., a transmission buffer of a socket), which means to move n bytes of data among data held by the application to the transmission buffer of the TCP socket. At this time, the TCP socket may be blocked and non-blocked. In a case where the TCP socket is blocked, and when the transmission buffer of the TCP socket is full, a following procedure of the write( ) command cannot proceed. Further, in a situation where the transmission buffer is full, and when the TCP socket is non-blocked, the following procedure of the write( ) command may proceed but data still cannot be transmitted to the transmission buffer.

It is not preferable to determine the size of the transmission buffer to have a small constant value in order to reduce socket latency time D1 of the transmission buffer of the TCP socket that operates as above due to a transmission rate declining problem as described hereinbefore.

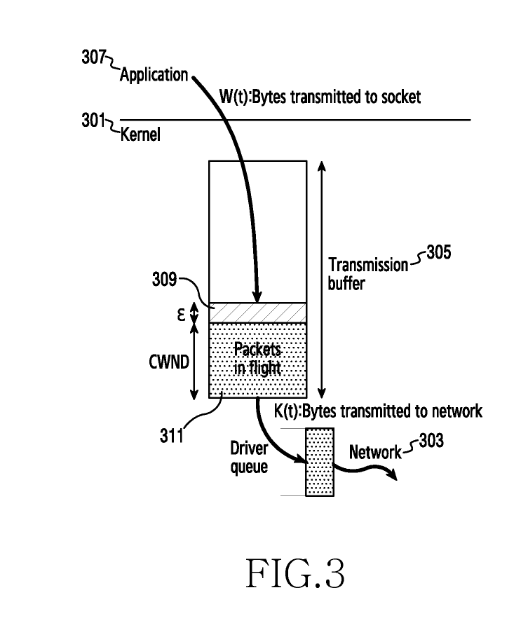

Therefore, various embodiments propose a TCP socket that has a transmission buffer having the structure as described in FIG. 3.

Referring to FIG. 3, with respect to a given TCP socket, the transmission end 210 may manage the total number of bytes of packets having been transmitted via a network 303 from a kernel 301 (i.e., a transmission buffer 305) through the TCP socket until time t. The number of total bytes of the packets having been transmitted via the network 303 from the kernel 301 through the TCP socket until time t may be referred to as K(t). The transmission end 210 may measure K(t) for time t.

Further, the transmission end 210 may manage the total number of bytes having been transmitted from an application 307 to the socket (i.e., the transmission buffer 305). The total number of bytes having been transmitted from the application 307 to the socket (i.e., the transmission buffer 305) until time t may be referred to as W(t). The transmission end 210 may measure W(t) for time t.

According to an embodiment, the transmission end 210 may observe and measure a value of W(t)−K(t). The transmission end 210 may control packet transmission from the application 307 to the socket (i.e., the transmission buffer 305) based on the measured value of W(t)−K(t). Accordingly, the transmission end 210 may adjust or control the amount of packets substantially accumulated in the transmission buffer 305 and a latency time caused thereby.

In other words, the size of the transmission buffer 305 may no longer be important. The present disclosure relates only to controlling the amount of packets substantially filling the transmission buffer 305, while letting the size of the transmission buffer 305 have a large value.

FIG. 3 shows a situation where the amount of packets substantially filling the transmission buffer 305 is configured to be epsilon(c) 309 according to a control of the transmission end 210. However, it should be noted here that the total amount of packets filling the transmission buffer 305 includes not only epsilon(c) 309, but also “packets in flight” 311 indicating the amount of packets that are being transmitted through the network but for which an ACK message has not yet been received.

As an aspect of implementation of the present disclosure, the transmission end 210 may use the program code as described below. That is, the transmission end 210 may use the program code in TABLE 2 below through the application 307.

TABLE 2

```
while (1) {
  if (W_t - K_t < epsilon)
    write (socket, buffer, n);
}
```

Referring to the program code, the write( )function is no longer blocked by the transmission buffer 305 thanks to the size of the transmission buffer configured to have a large value. That is, the transmission buffer 305 may be blocked or non-blocked by a condition relating to W(t)−K(t). For example, when a value of W(t)−K(t) is smaller than a predefined E 309, the transmission end 210 may non-block the transmission buffer and fill the transmission buffer with packets transmitted from the application. Contrarily, when the value of W(t)−K(t) is equal to or larger than the predefined ∈ 309, the transmission end 210 may block the transmission buffer.

Implementation of a system call is necessary for the application 307 to call K(t), and the corresponding system call may be implemented in a form in which the total amount of packets transmitted through the network from a TCP stack within the kernel is counted.

Further, in other embodiment, a condition of controlling W(t)−K(t) by the transmission end 210 may be generalized through the following EQUATION 2.

W(t)−K(t)<f(RTT(t),Tput(t)) [EQUATION 2]

In EQUATION 2, RTT(t) denotes a round trip latency time (round trip time) that a corresponding session experiences at time t, and Tput(t) denotes a network transmission rate (throughput).

EQUATION 2 signifies that a low latency system suitable for a given situation may be created by controlling the amount of packets buffered in the TCP socket, that is, the amount of packets filling the transmission buffer on the basis of the round trip latency time RTT(t) and the network transmission rate Tput(t).

In other words, the transmission end 210 may control blocking/non-blocking of the transmission buffer 305 through a comparison of W(t)−K(t) with f(RTT(t), Tput(t)). The f(RTT(t), Tput(t)) may be referred to as a reference value for a socket control.

For example, when it is assumed that the network environment has a high network transmission rate Tput(t), a value of the right side of Equation 2 may be determined to be large and, as a result, the amount of the packets filling the transmission buffer by the transmission end 210 may be determined to be large. As a result, the transmission buffer may be non-blocked. Contrarily, when it is assumed that the network environment has a low network transmission rate Tput(t), the value of the right side of Equation 2 may be determined to be small and, as a result, the amount of the packets filling the transmission buffer by the transmission end 210 may be determined to be small. As a result, the transmission buffer may be blocked.

In another example, it may be assumed that the network environment has a large round trip latency time RTT(t). In this case, the value on the right side of Equation 2 may be determined to be small. Accordingly, the amount of the packets filling the transmission buffer by the transmission end 210 may be determined to be small and, as a result, the transmission buffer may be blocked. Contrarily, it may be assumed that the network environment has a small round trip latency time RTT(t). In this case, the value of the right side of Equation 2 may be determined to be large. Accordingly, the amount of the packets, which are used to fill the transmission buffer by the transmission end 210, may be determined to be large and, as a result, the transmission buffer may be non-blocked.

As described hereinbefore, the present disclosure may be implemented through collaboration of the application and the kernel in the transmission end 210, or may be implemented only by modification in the kernel. This can be achieved only by leaving, within the kernel, a function for counting W(t) transferred by the socket from the application or a function for measuring the same, in which the application may call the write 0 function in the same way as before.

An operation method of a transmission device for reducing a transmission latency time according to an embodiment includes: determining the amount of packets transferred from an application layer to a buffer; determining the amount of packets transferred from the buffer to a transmission layer; and blocking a packet transfer from the application layer to the buffer based on the amount of packets transferred from the application layer to the buffer and the amount of packets transferred from the buffer to the transmission layer.

Blocking of the packet transfer according to another embodiment includes: determining a difference value between the amount of packets transferred from the application layer to the buffer and the amount of packets transferred from the buffer to the transmission layer; and determining whether to block the packet transfer to the buffer, based on the difference value.

Blocking of the packet transfer according to still another embodiment includes: comparing the difference value with a threshold value; and blocking the packet transfer to the buffer when the difference value is equal to or larger than the threshold value.

Blocking of the packet transfer according to still another embodiment includes determining whether to block the packet transfer, based on the difference value and a round trip latency time (round trip time).

Blocking of the packet transfer according to still another embodiment includes determining whether to block the packet transfer, based on the difference value and a network transmission rate (throughput).

The amount of packets transferred from the application layer to the buffer and the amount of packets transferred from the buffer to the transmission layer according to another embodiment are determined by a function of time.

The operation method of a transmission device according to another embodiment further includes determining a function value of f(RTT(t), Tput(t)) having, as independent variables, a round trip latency time (round trip time) and a network transmission rate (throughput).

Blocking of the packet transfer according to still another embodiment includes determining whether to block the packet transfer, based on a comparison of the difference value with the function value f(RTT(t), Tput(t)).

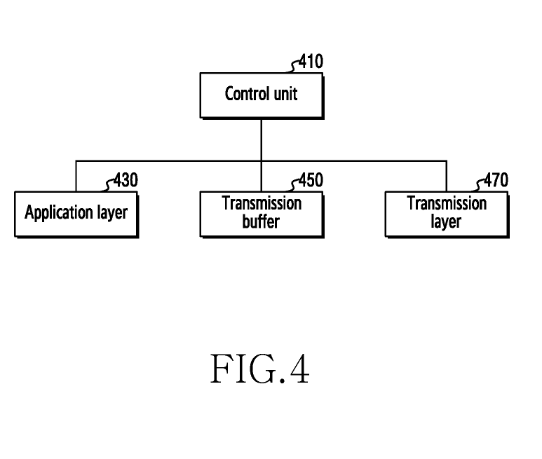

FIG. 4 illustrates a functional block configuration of a transmission end, for example, transmission end 210 of FIG. 2, according to an embodiment. The transmission end may be referred to as a transmission device, a base station (device), a terminal (device), a server (device), and the like. Referring to FIG. 4, the transmission end may include a control unit 410, an application layer 430, a transmission buffer 450, and a transmission layer 470.

The control unit 410 may control an overall operation of the transmission end. The control unit 410 may control states and operations of all elements constituting the transmission end. The control unit 410 may control generation of a program code modified in the application layer 430 in order to transfer a packet. Particularly, the control unit 410 may perform control to generate a code modified based on a value of W(t)−K(t) in the application layer 430. The control unit 410 may determine whether to transfer a packet from the application layer 430 to the transmission buffer 450 of the TCP socket based on the modified program code. According to an embodiment, the control unit 410 may determine whether to transfer a packet from the application layer 430 to the transmission buffer 450 of the TCP socket in accordance with EQUATION 2.

The application layer 430 may generate a packet according to a preconfigured program and a user input at the transmission end. When the generated packet becomes a transmission object, the application layer 430 may transfer the generated packet to the transmission buffer 450 of the TCP socket under control of the control unit 410. That is, the application layer 430 may control blocking/non-blocking of the transmission buffer of the TCP socket under control of the control unit 410 through the modified program code.

The transmission buffer 450 of the TCP socket may temporarily store the packet generated in the application layer 430 for the purpose of transmitting the packet to the reception end through the network under control of the control unit 410. The transmission buffer 450 may be blocked/non-blocked based on the modified program code of the application layer 430 under control of the control unit 410. The transmission buffer 450 may transfer the stored packet to the transmission layer 470 under control of the control unit 410. For the packet transmitted through the network, the transmission buffer 450 may delete the transmitted packet under control of the control unit 410 when ACK message for the packet is received from the reception end, for example, reception end 250 of FIG. 2.

The transmission layer 470 may provide a function for transparent transmission of a packet, between the transmission end 210 and the reception end 250 under control of the control unit 410.

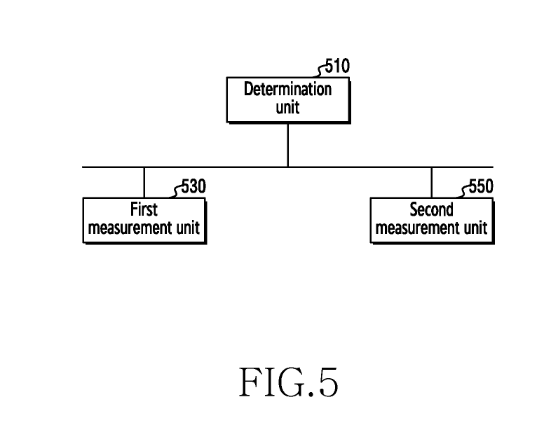

FIG. 5 illustrates a functional block configuration of a control unit according to an embodiment. The block configuration may correspond to the control unit 410 illustrated in FIG. 4.

Referring to FIG. 5, the control unit includes a first measurement unit 530, a second measurement unit 550, and a determination unit 510. The first measurement unit 530 may measure or determine the amount W of packets transferred to the buffer of the TCP socket, in which the packets have been generated in the application layer. The W may be expressed as a function of time W(t). That is, the first measurement unit may measure or determine the amount W(t) of packets transferred to the buffer of the TCP socket in the application layer until time t.

The second measurement unit 550 may measure or determine the total amount K of packets having been transmitted from the transmission buffer of the TCP socket through the network. The K may be expressed as a function of time K(t). That is, the second measurement unit may measure or determine the total amount K(t) of packets having been transmitted from the transmission buffer of the TCP socket through the network until time t.

The determination unit 510 may control blocking/non-blocking of the transmission buffer of the TCP socket. Particularly, the determination unit 510 may control blocking/non-blocking of the transmission buffer based on the W(t) and the K(t). Particularly, the determination unit 510 may control blocking/non-blocking of the transmission buffer based on a value of W(t)−K(t). According to an embodiment, the determination unit 510 may control blocking/non-blocking of the transmission buffer through a comparison of the value of W(t)−K(t) with a preconfigured constant value ∈. That is, the determination unit 510 may non-block the transmission buffer when it is determined that the value of W(t)−K(t) is smaller than epsilon(E). Contrarily, the determination unit 510 may block the transmission buffer when it is determined that the value of W(t)−K(t) is larger than or equal to ∈.

According to another embodiment, the determination unit 510 may control blocking/non-blocking of the transmission buffer based on a round trip latency time RTT(t) and a network transmission rate Tput(t). The determination unit 510 may determine a function f(RTT(t), Tput(t)) in order to control blocking/non-blocking of the transmission buffer. The function f(RTT(t), Tput(t)) has the round trip latency time RTT(t) and the network transmission rate Tput(t), as independent variables. For example, depending on a network state, f(RTT(t), Tput(t)) may be a small value when round trip latency time RTT(t) is relatively large, and f(RTT(t), Tput(t)) may be a large value when RTT(t) is relatively small. This is because a case where RTT(t) is large shows that packet transmission is not smooth in the network. In another example, depending on a network state, f(RTT(t), Tput(t)) may be a large value when the network transmission rate Tput(t) is relatively large, and f(RTT(t), Tput(t)) may be a small value when Tput(t) is relatively small. This is because a case where Tput(t) is large shows that packet transmission is smooth in the network.

The determination unit 510 may control blocking/non-blocking of the transmission buffer by comparing W(t)−K(t) with f(RTT(t), Tput(t)). The determination unit 510 may control blocking/non-blocking of the transmission buffer using EQUATION 2. For example, the determination unit 510 may determine to non-block the transmission buffer when a value of W(t)−K(t) is smaller than a value of f(RTT(t), Tput(t)). Contrarily, the determination unit 510 may determine to block the transmission buffer when the value of W(t)−K(t) is equal to or larger than the value of f(RTT(t), Tput(t)).

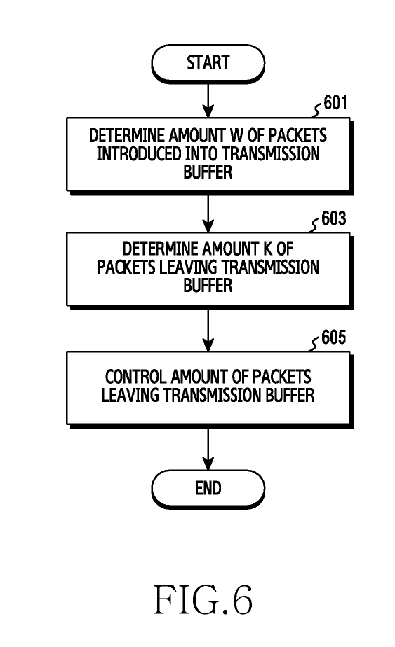

FIG. 6 illustrates an operation flow of a transmission end according to an embodiment. The transmission end in FIG. 6 corresponds to the transmission end 210 in FIG. 2.

Referring to FIG. 6, the transmission end may determine the amount W of packets transferred to the transmission buffer of the TCP socket, in step 601. The transmission end may determine the amount W of packets transferred to the transmission buffer of the TCP socket for the purpose of transmitting the packets to the reception end, such as reception end 250 of FIG. 2, in which the packets have been generated in the application layer. W may be expressed as a function of time W(t). That is, the transmission end 210 may determine the amount W(t) of packets transferred to the transmission buffer until time t.

The transmission end may determine the amount K of packets transferred from the transmission buffer of the TCP socket through the network, in step 603. K may be expressed as a function of time K(t). That is the transmission end may determine the amount K(t) of packets transferred from the transmission buffer through the network until time t.

The transmission end may control the amount of packets of the transmission buffer, in step 605. The transmission end may control blocking/non-blocking of the transmission buffer using the W(t) and the K(t). For example, the transmission end may control blocking/non-blocking of the transmission buffer through a comparison of a value of W(t)−K(t) with a predefined constant value ∈. A detailed operation method is the same as that described in

FIG. 5. In another example, the transmission end may define f(RTT(t), Tput(t)) having, as independent variables, a round trip latency time RTT(t) and a network transmission rate Tput(t), and control blocking/non-blocking of the transmission buffer by comparing the function with the value of W(t)−K(t). A detailed operation method is the same as that described in FIG. 5.

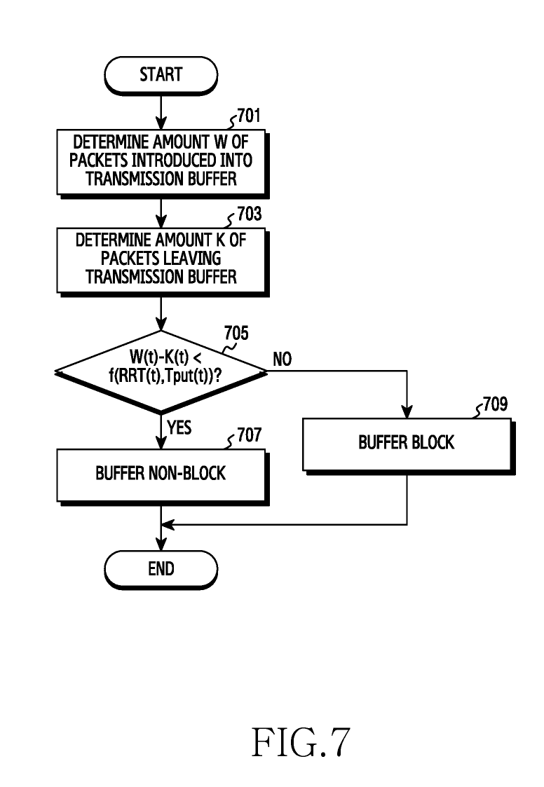

FIG. 7 illustrates another operation flow of a transmission end according to an embodiment. The transmission end in FIG. 7 corresponds to the transmission end 210 in FIG. 2.

In FIG. 7, step 701 of determining the amount W of packets transferred to the transmission buffer and step 703 of determining the amount K of packets having been transmitted from the transmission buffer are the same as steps 601 and 603 in FIG. 6. Therefore, detailed descriptions thereof are omitted.

The transmission end determines whether a value of W(t)−K(t) is smaller than a value of f(RTT(t), Tput(t)), in step 705. Particularly, the transmission end may determine the value of W(t)−K(t) using the W(t) having been determined in step 701 and the K(t) having been determined in step 703. Further, the transmission end may determine f(RTT(t), Tput(t)) having, as independent variables, a round trip latency time RTT(t) and a network transmission rate Tput(t). As a result, the transmission end 210 may determine whether the value of W(t)−K(t) is smaller than the value of f(RTT(t), Tput(t)).

When it is determined in step 705 that the value of W(t)−K(t) is smaller than the value of f(RTT(t), Tput(t)), the transmission end may determine to non-block the transmission buffer of the TCP socket in step 707.

Contrarily, when it is determined that the value of W(t)−K(t) is equal to or larger than the value of f(RTT(t), Tput(t)), the transmission end may determine to block the transmission buffer in step 709.

A storage device and a storage medium correspond to embodiments of a program including instructions for performing embodiments or a machine-readable storage means suitable for storing programs when executed. Embodiments of the present disclosure provide a program including codes for implementing a device or a method as defined in any one of the appended claims, and a machine-readable storage medium storing such a program. Further, the programs may be electrically transferred to a medium, such as a communication signal transferred through a wired or a wireless connection, and embodiments properly include the equivalents.

Methods according to embodiments stated in claims and/or specifications of the present disclosure may be implemented in hardware, software, or a combination of hardware and software.

The software may be stored in a computer-readable storage medium. The computer-readable storage medium stores at least one program (software module) including instructions that causes, when executed by at least one processor in the electronic device, the electronic device to perform the method of the present disclosure.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs) or other type optical storage devices, or a magnetic cassette. Alternatively, any combination of some or all thereof may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access a device performing an embodiment of the present disclosure, via an external port. Further, a separate storage device on the communication network may access the device performing an embodiment of the present disclosure.

In the above-described detailed embodiments of the present disclosure, a component included in the present disclosure is expressed in the singular or the plural according to a presented detailed embodiment. However, the singular form or plural form is selected for convenience of description suitable for the presented situation, and various embodiments of the present disclosure are not limited to a single element or multiple elements thereof. Further, either multiple elements expressed in the description may be configured into a single element or a single element in the description may be configured into multiple elements.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An operation method of a transmission device, comprising:
determining an amount of packets transferred from an application layer to a buffer;
determining an amount of packets transferred from the buffer to a transmission layer; and
blocking a packet transfer from the application layer to the buffer, based on the amount of packets transferred from the application layer to the buffer and the amount of packets transferred from the buffer to the transmission layer.

2. The operation method of claim 1, wherein blocking the packet transfer comprises:
determining a difference value between the amount of packets transferred from the application layer to the buffer and the amount of packets transferred from the buffer to the transmission layer; and
determining whether to block the packet transfer to the buffer based on the difference value.

3. The operation method of claim 2, wherein blocking the packet transfer comprises:
comparing the difference value with a threshold value; and
blocking the packet transfer to the buffer when the difference value is equal to or larger than the threshold value.

4. The operation method of claim 2, wherein blocking the packet transfer comprises determining whether to block the packet transfer based on the difference value and a round trip latency time.

5. The operation method of claim 2, wherein blocking the packet transfer comprises determining whether to block the packet transfer based on the difference value and a network transmission rate.

6. The operation method of claim 2 further comprises determining a reference value based on a round trip latency time and a network transmission rate.

7. The operation method of claim 6, wherein blocking the packet transfer comprises blocking the packet transfer when the difference value is equal to or larger than the reference value.

8. The operation method of claim 1, wherein the amount of packets transferred from the application layer to the buffer and the amount of packets transferred from the buffer to the transmission layer are determined by a function of time.

9. A transmission device comprising:
a buffer configured to temporarily store a packet; and
at least one processor configured to block a packet transfer to the buffer based on an amount of packets transferred from an application layer to the buffer and an amount of packets transferred from the buffer to a transmission layer.

10. The transmission device of claim 9, wherein the at least one processor is configured to determine whether to block the packet transfer to the buffer based on a difference value between the amount of packets transferred from the application layer to the buffer and the amount of packets transferred from the buffer to the transmission layer.

11. The transmission device of claim 10, wherein the at least one processor is configured to:
compare the difference value and a threshold value; and
block the packet transfer to the buffer when the difference value is equal to or larger than the threshold value.

12. The transmission device of claim 10, wherein the at least one processor is configured to determine whether to block the packet transfer based on the difference value and a round trip latency time.

13. The transmission device of claim 10, wherein the at least one processor is configured to determine whether to block the packet transfer, based on the difference value and a network transmission rate.

14. The transmission device of claim 10, wherein the at least one processor is configured to:
determine a reference value based on a round trip latency time and a network transmission rate; and
block the packet transfer when the difference value is equal to or larger than the reference value.

15. The transmission device of claim 9, wherein the amount of packets transferred from the application layer to the buffer and the amount of packets transferred from the buffer to the transmission layer are determined by a function of time.

16. A non-transitory computer readable medium embodying a computer program, the computer program comprising computer readable program code that when executed causes at least one processing device to:
determine an amount of packets transferred from an application layer to a buffer;
determine an amount of packets transferred from the buffer to a transmission layer; and
block a packet transfer from the application layer to the buffer, based on the amount of packets transferred from the application layer to the buffer and the amount of packets transferred from the buffer to the transmission layer.

17. The non-transitory computer readable medium of claim 16, wherein blocking the packet transfer comprises:
determining a difference value between the amount of packets transferred from the application layer to the buffer and the amount of packets transferred from the buffer to the transmission layer; and
determining whether to block the packet transfer to the buffer based on the difference value.

18. The non-transitory computer readable medium of claim 17, wherein blocking the packet transfer comprises:
comparing the difference value with a threshold value; and
blocking the packet transfer to the buffer when the difference value is equal to or larger than the threshold value.

19. The non-transitory computer readable medium of claim 17, wherein blocking the packet transfer comprises determining whether to block the packet transfer based on the difference value and a round trip latency time.

20. The non-transitory computer readable medium of claim 17, wherein blocking the packet transfer comprises determining whether to block the packet transfer based on the difference value and a network transmission rate.
